(19) United States
(12) Patent Application Publication
(10) Pub. No.: US 2015/0124630 A1
(43) Pub. Date: May 7, 2015

(54) AUTOMATIC LOCATION IDENTIFICATION OF CABLE Wi-Fi AND SMALL CELL NODES IN HFC NETWORKS AND THEIR INTEGRATION INTO INVENTORY DATABASES

(71) Applicant: ARRIS ENTERPRISES, INC., Suwanee, GA (US)

(72) Inventors: Sebnem Zorlu Ozer, Perkasie, PA (US); Dean A. Stoneback, Harleysville, PA (US)

(73) Assignee: ARRIS ENTERPRISES, INC., Suwanee, GA (US)

(21) Appl. No.: 14/073,957

(22) Filed: Nov. 7, 2013

(51) Int. Cl. H04L 12/26

(52) U.S. Cl. CPC H04L 43/10
USPC 370/252

(57) ABSTRACT

Location determination software is provided to determine the location of cable Wi-Fi nodes that do not have integrated GPS by using HFC and Wireless domain techniques. The location identification solutions include (1) using ranging, trilateration and common channel characteristics analysis with other CMs and fiber nodes, (2) ranging using transit delay (3) determining location based on a nearby gateway or tap, and (4) determining location from a nearby mobile device with GPS. The location information can be provided in a unified database for access by other Wi-Fi transmission devices and HFC components.

### BACKGROUND

1. Technical Field

The present invention relates to a system for locating a Wi-Fi transmission device where the Wi-Fi transmission device does not have an integrated Global Positioning System (GPS). More particularly, the present invention relates to determining the position of a cable network node that provides Wi-Fi transmission to deliver communication signals, where the Wi-Fi transmission device does not have GPS.

2. Related Art

New Cable Wireless Nodes (e.g. Cable Wi-Fi and small cell nodes) that transmit Wi-Fi signals to display devices such as tablet computers, cell phones and wireless televisions have integrated GPS for automatic location identification (ALI). However, most of the current deployments around the world have older nodes without GPS. Some cable service providers aim to upgrade their wireless node deployments while others extend to new locations by keeping existing systems. Both managing existing systems and upgrading processes require accurate location identification of nodes. However, existing systems without GPS rely on manual physical location identification which is an error prone process. This results in losing equipment, additional onsite work and overall poor Fault, Configuration, Accounting, Performance and Security (FCAPS) management.

Service providers that supply the nodes, include cable television system providers, DSL providers, and fiber network providers that offer Wi-Fi access, for example in outdoor hotspots, shopping malls or airports where users can connect tablets, cell phones or computers. These service providers want cheaper versions of these nodes or Access Points (APs) including outdoor carrier Wi-Fi equipment, or other mobile indoor Wi-Fi. The service providers want to have an automatic way of getting AP's physical location information to assist with deployment and operations or for location based services, even while existing wireless deployments may not have integrated GPS to lower the cost. Furthermore GPS may not work well in some deployment scenarios such as indoor hotspots.

Most existing Hybrid Fiber Coaxial (HFC) network architectures maintain a separate wireless Network Management System (NMS). If both systems are managed together a two-fold gain is possible: 1) Wireless nodes with GPS or other Approximate Location Information (ALI) techniques may help to locate or validate the location of other HFC components; 2) HFC components with known location may help to locate or validate the location of wireless nodes. The latter is also helpful for cases where AP or 3G/4G node is not operational but CM is still reachable.

The above systems show that GPS is not always available or preferred and other ALI mechanism solutions that can provide approximate location information are needed. Non-GPS based solutions are desirable for service providers that already have deployments with Cable Wi-Fi nodes without GPS or are interested in low cost outdoor Wi-Fi nodes. Integration of wireless and cable with location information when GPS is not available in all systems may also be desired by service providers that want to have a unified monitoring and inventory system.

### SUMMARY

For older nodes that do not include GPS, embodiments of the present invention provide software based ALI identification solutions. The following, software based ALI solutions are provided using integration of wireless AP nodes into coaxial, HFC and other network architectures.

The software uses network segment identification, ranging and channel characteristics' analysis to locate the cable modem (CM) that is to be located is included in a network segment, or serving fiber node. If the serving fiber node is not known for the Cable Wi-Fi node, a first set of steps needed is to determine its network neighborhood. U.S. Pat. No. 7,742,697, describes these steps used to identify when CMs are connected to the same optical node by instructing two CMs, one with a known location and another with an unknown location to transmit at frequencies f1 and f2 to detect any intermodulation distortion at frequency f3 where intermodulation distortion would be expected when transmissions occur both at f1 and f2. If intermodulation is produced which exceeds a threshold, then the two CMs are determined to be in that network fiber node where measurement is made. Further steps in the method are then applied with steps of the '697 patent to determine the relative location of the unknown Wi-Fi CM node when the CMs, are co-located in the same network segment as described to follow.

First in the location determination method are steps provided when the fiber node location is known and includes ranging to estimation of the general location of the cable wireless node relative to the determined fiber node. If the location of the fiber node is known, a general location of the cable wireless node can be estimated relative to the fiber node. Otherwise, steps of ranging are applied with trilateration to determine the fiber node location. This method applies the steps of ranging and geometry of circles or triangles from location information of three or more CMs that are not aligned with the fiber node, so that the location of fiber node may be identified (this is the trilateration method). Using all this information, a general location of the cable wireless node can be estimated within a circular area. Then, using additional information that the operator may have (e.g. Cable Wi-Fi node is integrated in a tap) and measuring common channel characteristics (e.g. equalization characteristics) behind a network component in the same segment, the location of the Cable Wireless node may be more specifically identified.

A second method uses location approximation with transit delay. In this method the device's location from a headend node is measured using the transit delay from the node to the device such as an HFC node with a known location determined to be connected to the AP node. In the case of an HFC powered Wi-Fi AP, the location will need to be on the cable strand somewhere. For instance, if you know that the AP is at a certain distance from the node, there are only a finite number of actual locations it can be. In order to cheaply calculate transit delay, IEEE 1588v2 type software may be used to determine transit delay for ranging. In particular, consider a system in which the remote unit (an HFC-powered Wi-Fi AP, for example) uses 1588 to derive exact Time of Day (TOD). Then, the AP can be queried to transmit its exact time of day to the headend. When the packet arrives, the TOD in the packet can be compared to the actual TOD. The difference would be the one-way transit delay. This method can also be used for non-DOCSIS links.

A third method uses the location of a nearby home or SMB (Small Medium Business) gateway. This method takes into account that low-cost Cable Wi-Fi options will be located primarily nearby a large group of houses and businesses that may have Multiple Service Operator (MSO) gateways. If a nearby MSO home/SMB gateway can be used to get APs info with Cable Wi-Fi SSIDs, it can be used for approximate location identification since home gateways location will be known to MSOs.

A fourth method uses a nearby mobile device with GPS. Many mobile devices, such as mobile phones, have integrated GPS and many users enable location related features. Cable Wi-Fi APs are typically located at places where multiple mobile device users connect. Therefore, an AP can make connections with GPS enabled mobile devices, such as cell phones, shortly after the AP is up and during its operation. Mobile phones, as well as other devices such as tablet computers can have software that provides their location information to the corresponding service management platforms. MSOs can use specific client apps for their subscribers as well as roaming partner users. The location information at different partner MSOs' service management platforms may be shared. Note that, IEEE 802.11 has location request and reply messages as a part of standardization that can be used for location information exchange. Depending on the chips used, if these IEEE 802.11 messages are available they can also be used for location identification purposes.

A fifth method may be implemented by Wi-Fi system operators that may integrate the location information data with their Home Location Register/Home Subscriber Server databases. Most mobile devices have both 3G/4G and Wi-Fi connections. When Wi-Fi mobile devices are connected to the AP, they can use the database information to identify their location as well as provide GPS location data to update the AP location. In this case, the location information is obtained from the mobile core and provided to the MSO's Wi-Fi service management platform.

A combination of multiple ones of the above techniques may be implemented to locate or validate the location of wireless AP nodes and HFC components in the overall network architecture.

### BRIEF DESCRIPTION OF THE DRAWINGS

Further details of the present invention are explained with the help of the attached drawings in which:

FIG. 1 is a block diagram illustrating a system that can utilize automatic location identification (ALI) Cable Wi-Fi AP nodes that provide Wi-Fi in cable and HFC networks but do not have an on board GPS;

FIG. 2 is a flow chart illustrating steps of a method for ALI of Cable Wi-Fi Access Point (AP) nodes that have no GPS, by using other CM devices and network nodes in the same network segment through ranging, trilateration and analysis of common channel characteristics;

FIG. 3 shows steps for determining the AP node location using transit delay from a network node with a known location;

FIG. 4 shows steps for determining the AP node location step of FIG. 2 using GPS information from a users mobile device or home/SMB gateway located nearby; and

FIG. 5 shows a block diagram of a system for locating an AP node showing details of internal components of the AP node as well as database memory provided in the head end system.

### DETAILED DESCRIPTION

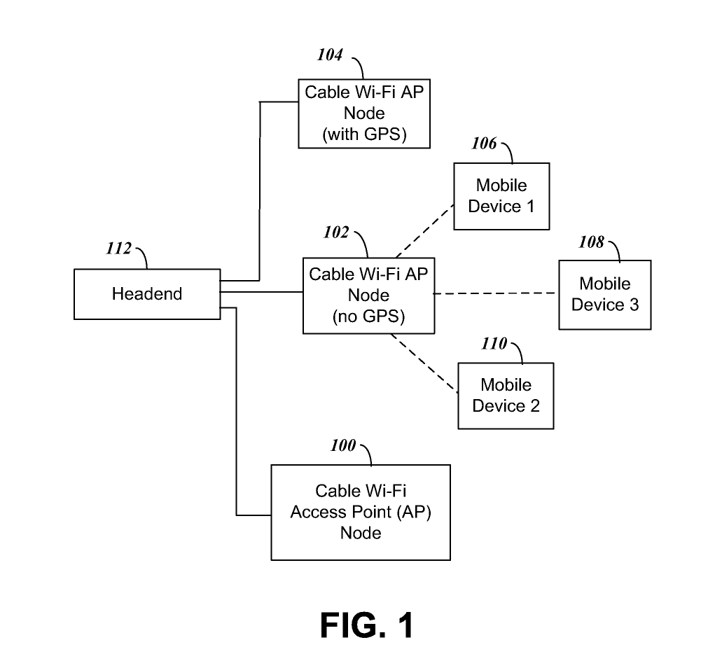

For older nodes that do not include GPS, embodiments of the present invention provide software based ALI identification solutions. FIG. 1 is a block diagram illustrating a system that can utilize automatic location identification (ALI) for Cable Wi-Fi AP nodes that provide Wi-Fi in cable and HFC networks but do not have an on board GPS. The system includes three AP nodes 100, 102 and 104 that provide Wi-Fi. Although AP nodes 100 and 104 include GPS location identification information, AP node 102 does not include GPS or other location identification equipment. The AP node 102 can be provided in a location such as metro areas, a shopping mall or a coffee shop to provide Wi-Fi to customers. As shown mobile devices 106, 108 and 110, which may be cell phones, tablets or PCs are Wi-Fi connected to AP node 102. The Cable Wi-Fi AP nodes 100, 102 and 104 can have a cable modem, or a DSL modem co-located with another Wi-Fi transmission network transmission device that distribute signals from a headend system 112.

Embodiments of the present invention enable an AP node such as 102, without built in location identification hardware, to determine location. The following, software based ALI solutions are provided using integration of wireless AP nodes into coaxial, HFC and other network architectures.

### A. Software Based ALI Solutions Using HFC Node Sites

A first method uses network segment identification, ranging and channel characteristics' analysis in HFC node sites to locate the CM in the Cable Wi-Fi node. If the network segment, e.g. the serving fiber node, for the Cable Wi-Fi node has an unknown location, the first step is to determine its network neighborhood. For example, U.S. Pat. No. 7,742,697, assigned to General Instrument Corporation, describes a method to identify when Cable Modems (CMs) are connected to the same optical node by instructing two CMs to transmit at frequencies f1 and f2 to detect any intermodulation distortion in the laser at frequency f3 where intermodulation distortion would be expected when transmissions occur both at f1 and f2. If intermodulation is produced which exceeds a threshold, then the two CMs are determined to be connected to the same fiber node where measurement is made. The same technique can be used for location determination of a CM in a Cable Wireless node that is connected to a fiber node. For this purpose, the CM with known location (e.g. a CM inside a subscriber's home) will transmit at f1 while CM in a Cable Wireless node will transmit at f2.

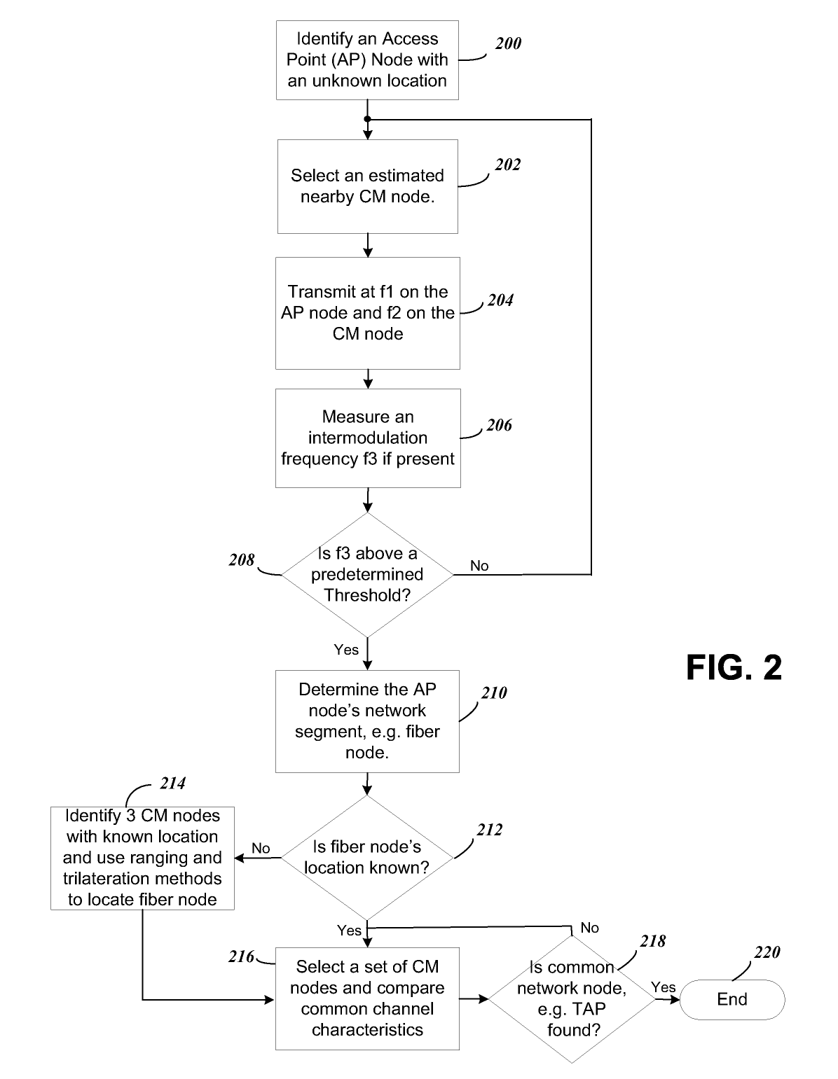

FIG. 2 is a flow chart illustrating steps of a method for ALI of Cable Wi-Fi Access Point (AP) nodes that have no GPS, including using steps from the '697 patent to determine if the AP node is located near other cable modem (CM) devices, as well as steps to enable using those CM devices to identify the AP node location. In step 200, an AP node is identified that has an unknown location that the ALI software will operate to determine a location. Next in step 202, at least one nearby CM node with known location is estimated to be in the same network as the AP node with an unknown location. The estimation may be based on manual location logs of APs, deployment plans or other network planning information. In step 204, frequencies f1 and f2 are transmitted from the CM node and AP node respectively to apply the steps of the '619 patent to determine if the AP node with an unknown location is located in the same network as the CM. In step 206, a measurement at frequency f3 is taken, f3 being the intermodulation frequency of f1 and f2. In step 208, a measurement of the signal level of f3 is made according to the '697 patent to determine if the AP node with unknown location is in the network with the CM node transmitting at f1. If not, the program indicates that the unknown AP node is not in the same network and returns to step 202 to select another CM connected to another fiber node in the network for location determination. When the signal level of f3 is high enough, in step 210, the program provides the network fiber segment, e.g. connected fiber node of the AP node.

Although the '697 patent enables determination if two CMs are connected to the same fiber node, the CMs specific location relative to the node is still unknown prior to step 212 of FIG. 2. In step 212, if the location of the fiber node is known, a general location of the cable wireless node can be estimated relative to the fiber node in step 216. Otherwise, the next step 214, uses ranging with trilateration to determine location by using location information of three CMs, that are not aligned with the fiber node, allowing the AP node location to be identified based on the computed fiber node location. For this step 214, DOCSIS ranging information of CMs are used to find the relative distance of CMs from the fiber node. Since CM's locations are known, the fiber node location is identified by using the trilateration method. Therefore, if the serving fiber node location is unknown, using all this information, a general location of the cable wireless node can be estimated within a circular area. Then, using additional information that the operator may have (e.g. Cable Wi-Fi node is integrated in a tap) a set of CMs that are connected to the same fiber node and estimated to be in the neighborhood of the AP node is selected before control is sent to step 216

In step 216, by measuring common channel characteristics behind a network component, the location of the Cable Wireless AP node may be more specifically identified. In step 218 a check is made to determine if a common channel characteristic identifies a tap. If so, the specific location is made, and control is sent to step 220 and the program ends. Otherwise, another set of CMs is selected in step 218 and control is sent to step 216 which is repeated for the new set of CMs. Measuring common channel characteristics in step 218 includes equalization characteristics to confirm that certain CMs are connected to the same tap. Note that based on a-priori information of the AP node's location, some steps of FIG. 2 may be omitted. For example, if the serving fiber node and its location are known, step 216 can be implemented directly to improve the location estimation within a smaller area.

An alternative method to locate the AP is to use transit delay to get an estimation of a device's location from a headend or plant node. A measurement is made of the transit delay from the node to the device such as a Cable Wi-Fi node with unknown location. In the case of an HFC powered Wi-Fi AP, the location will need to be on the cable strand somewhere. For instance, if you know that the AP is 1462 feet from the node, there are only a finite number of actual locations it can be. In order to cheaply calculate transit delay, IEEE 1588v2 type software may be used to determine transit delay. In particular, consider a system in which the remote unit (Wi-Fi AP, for example) uses 1588 to derive exact Time of Day (TOD). Then, the AP can be queried to transmit its exact time of day to the headend. When the packet arrives, the TOD in the packet can be compared to the actual TOD. The difference would be the one-way transit delay. This method can also be used for Wi-Fi nodes without DOCSIS backhaul, i.e. fiber Ethernet backhaul.

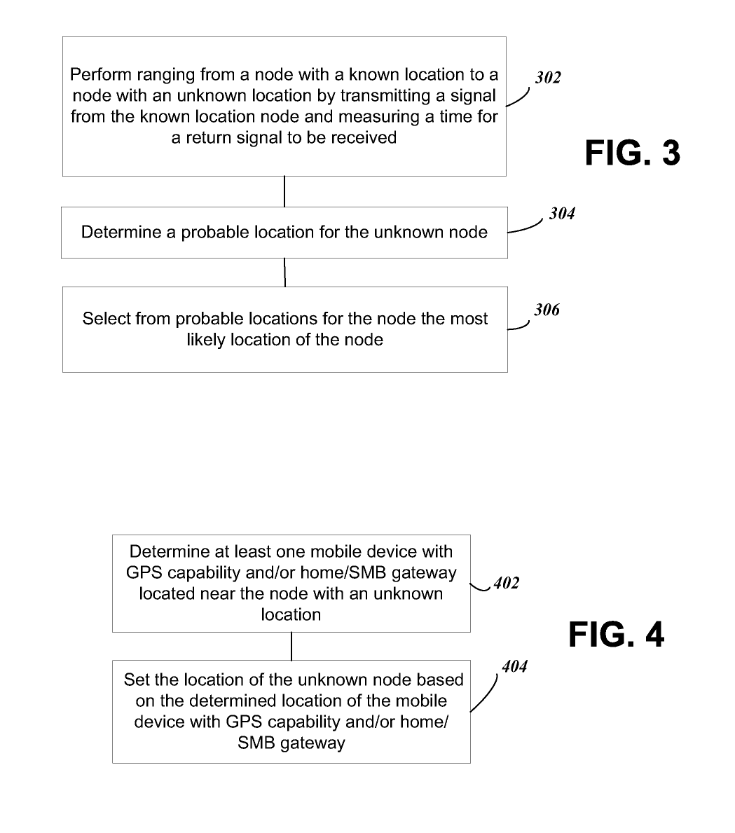

FIG. 3 shows steps that uses transit delay for location approximation. Initially in step 302 ranging is performed with a node having a known location to an AP node with an unknown location by transmitting a signal from the known location node and measuring a time for a return signal to be received. In step 304, with the range of the AP node known, a probable location for the AP node can be found in the determined range based on known areas that the AP node will likely be located, such as at a mall or coffee shop at that range or by using techniques such as analysis of common channel characteristics of neighbor nodes. Finally, in step 306 the most probable location of the AP node is selected.

### B. Software Based ALI Solutions Using Wireless Node Sites

With or Without a HFC network environment, wireless node sites which have location information, including Wi-Fi devices with GPS, can be used to provide location. The following sections describe methods for determining location using wireless nodes.

### 1. Using Location of Nearby Gateway

Another method to locate an AP takes into account that low-cost Cable Wi-Fi options will be located primarily nearby a large group of houses and businesses that may have a Multiple Service Operator (MSO) home/SMB gateway. If a nearby MSO gateway can be used to get APs info with Cable Wi-Fi SSIDs, it can be used for approximate location identification since home gateways location will be known to MSOs. For this purpose, MSOs may have a common software implementation to have gateways and Cable Wi-Fi nodes to detect their SSIDs and unique identifiers to be processed for a database that combines indoor and outdoor nodes' information.

### 2. Using Wireless Mobile Device with GPS or Known Location

Many mobile devices, such as mobile phones, have integrated GPS and many users enable location related features. Cable Wi-Fi APs are typically located at places where multiple mobile device users connect. Therefore, an AP can make connections with GPS enabled mobile devices, such as cell phones, shortly after the AP is up and during its operation. Mobile phones, as well as other devices such as tablet computers can have software that provide their location information to the corresponding service management platforms. MSOs can use specific client apps for their subscribers as well as roaming partner users. The location information at different partner MSOs' service management platforms may be shared. Wi-Fi connection between the cable AP and the mobile device with GPS provides a way to get users' location information when the user is connected to an AP without a known location. Note that, IEEE 802.11 has location request and reply messages as a part of standardization that can be used for location information exchange. Depending on the chips used, if these IEEE 802.11 messages are available they can also be used for location identification purposes.

Accordingly, one embodiment of the present invention provides an algorithm that gets location information for the AP or one of the CMs is by obtaining it though a Wi-Fi connection between the cable AP and a user's mobile device that has an accurate location to use to get the user's location information to identify the AP's location. Software may be specific to the Wi-Fi service management platform or can be an open platform. For example, an application may use location identification services Application Program Interfaces (APIs) when users consent to cable Wi-Fi terms (users may opt out).

Another method is where Wi-Fi system operators may integrate the location information obtained with embodiments of the present invention with their Business Intelligence software as a proprietary software option. Telco and Mobile Virtual Network Operator (MVNO) and other service providers that support mobile device networks can integrate the location data with their Home Location Register/Home Subscriber Server (HLR/HSS) databases (for example during the EAP-SIM/AKA processing which is a mechanism for authentication and session key generation using a mobile device network where user credentials are used for Wi-Fi connection). Most mobile devices have both 3G/4G and Wi-Fi connections, so EAP-SIM/AKA type solutions may be used to include user location for cable and telco hotspots. Thus, when Wi-Fi mobile devices are connected to the AP, MSOs' service management platforms can be integrated with mobile core to extract users' location and use this information to identify AP node's location.

FIG. 4 shows steps that for using a nearby mobile device with GPS or a home/SMB gateway for determining AP node location. Initially in step 402 nearby mobile devices with GPS capability and/or home/SMB gateways are identified within range of the AP node with an unknown location. Next in step 404, the mobile device GPS determined location and/or home/SMB gateways' locations are used to set the location of the AP node with an unknown location. Mobile devices' location information may be extracted from the device's software or service management software integrated with the mobile core.

### C. Combined Software Based ALI Solutions

The above location solutions, including HFC solutions in section A and wireless solutions in section B, can be combined. Combined solutions are described in the following sections.

### 1. Integration of the Software Systems

A combination of multiple ones of the above techniques may be implemented to locate or validate the location of wireless AP nodes and HFC components in the overall network architecture. For example, if the AP wireless link is broken, the location can be verified by using HFC node site. On the other hand, if a Cable Wi-Fi AP node location is determined based on nearby mobile devices with GPS according to the present invention and is connected to a tap with other HFC components having an unknown location, by using common channel characteristics other HFC components location may be validated.

### 2. Combined Inventory and Business Intelligence

Both HFC and Wireless domain information and techniques may be combined to create a unified database of cable nodes including traditional HFC components and Cable Wi-Fi nodes in the plant. Such a unified approach improves overall FCAPS management and bandwidth and power allocation. Prior to storage of location in a unified database, several rules may be accessed to determine if the location information is accurate enough. One such rule is to only get location information from mobile nodes with integrated GPS and home gateways. Such a rule increases the confidence level for the physical registration obtained. The algorithm or method can set the location information based on multiple inputs from multiple users with mobile devices close to the AP at startup. Then when there is a big change, such as an indication that the AP is moved, as indicated based on confidence levels that may be determined by the number of inputs, the AP location can be updated and also validated by using HFC domain information.

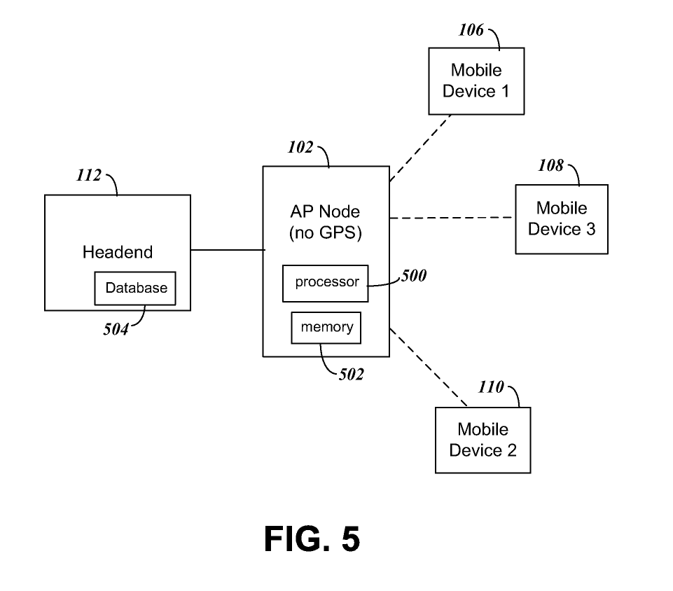

FIG. 5 shows a block diagram of components of the system of FIG. 1 that illustrates the system capability for identifying location. As shown, the headend 112 can include a database 504 for storing location information for CM nodes connected to the headend 112. Although the database 504 is shown included in the headend 112, it can similarly be included elsewhere in the network system. Also shown in FIG. 5 are the processor 500 and memory 502 provided in the AP node 102. The memory 502 can store control code to cause the processor 500 to execute code to perform the processes described above to determine the location of the AP node 102. Although the processor 500 and memory 502 are shown included in the AP node 102, these components can be included elsewhere in the network and accessed by the AP node 102.

1. A method for physically locating an Access Point (AP) node in a network, wherein the AP provides Wi-Fi access to multiple users, the method comprising:
transmitting a first signal at a frequency f1 from a first cable modem (CM) transmission device with a known physical location in the network;
transmitting a second signal at a frequency f2 from a Cable Wi-Fi device provided at the AP node;
measuring to determine if a signal at frequency f3 is present above a predetermined level, wherein the frequency f3 is an intermodulation frequency;
when the frequency f3 is identified at the predetermined level, applying a location determination technique to determine the location of the AP node relative to a fiber node that both the first CM and the Wi-Fi device are connected to,
wherein when a location of the fiber node is not known, the location determination technique comprises locating three cable modems with known location connected to the fiber node, and apply triangulation and ranging information to determine the fiber node location,
wherein the determined location of the fiber node is used with ranging to determine the AP node location relative to the fiber node, and
wherein the ranging is used to determine location for the AP node without Wi-Fi location information, the method further comprising estimating from cable modems connected to the same network segment in the area of the AP node using common channel characteristics to determine location of the AP node.

2-4. (canceled)

5. The method of claim 1, wherein the location determination technique comprises using transit delay, wherein a fiber node in the network with a known location sends a signal to AP node which provides a response to the signal within a known delay time, and wherein the total time to receive the response signal at the fiber node is measured to determine the distance from the fiber node to the AP node to determined the location of the AP node.

6. The method of claim 1, wherein the network comprises at least one of a cable network, a DSL network or a hybrid fiber-optic cable (HFC) network.

7. The method of claim 1, wherein the location determination technique comprises using a given mobile device located close to the AP with GPS capability to locate the AP.

8. The method of claim 1, wherein the location determination technique comprises using a nearby business gateway or home gateway with known location to locate the AP.

9-14. (canceled)
